(19) United States
(12) Patent Application Publication
(10) Pub. No.: US 2017/0058966 A1
(43) Pub. Date: Mar. 2, 2017

(54) ROTOR FLANGE WITH NON-UNIFORM SHAPE

(71) Applicant: Halla Visteon Climate Control Corp., Daejeon (KR)

(72) Inventor: Alfred Lim Poy, Livonia, MI (US)

(21) Appl. No.: 14/835,809

(22) Filed: Aug. 26, 2015

(51) Int. Cl. F16D 13/60; F16D 27/112

(52) U.S. Cl. CPC F16D 13/60; F16D 27/112

(57) ABSTRACT

A rotor for an electromagnetic clutch assembly includes a substantially cylindrical main body extending from a first end to a second end. The first end of the main body is configured to engage an armature of the electromagnetic clutch assembly and includes a first flange formed around a circumference thereof. The second end of the main body includes a second flange formed around a circumference thereof. One of the first flange or the second flange has a non-uniform cross-sectional shape as the one of the first flange or the second flange extends circumferentially around the main body, wherein the cross-sectional shape of the one of the first flange or the second flange taken through a plane extending parallel to an axis of rotation of the main body.

### FIELD OF THE INVENTION

The invention relates to an electromagnetic clutch assembly, and more particularly to a rotor of the electromagnetic clutch assembly having a non-uniform shape about a circumference of the rotor.

### BACKGROUND OF THE INVENTION

Automobiles commonly include several components that are driven by transmission of a torque from an output shaft of an engine (or other driving mechanism) to the desired vehicle components. In order to prevent inefficient operation of the automobile, it is often desirable to transmit the torque to the components when the operation thereof is required by the automobile or when the use is desirable to a passenger in the automobile. Such a component may be a compressor forming a component of a heating, ventilating, and air conditioning (HVAC) system of the automobile, as use of the compressor may be dependent on the desire of the user and the conditions of the ambient environment. Accordingly, an electromagnetic clutch assembly may be used to selectively transmit the torque from the automobile engine to the compressor.

FIG. 1 illustrates a cross-sectional view of a common prior art configuration of an electromagnetic clutch assembly 1 for use with a compressor 10, wherein the electromagnetic clutch assembly 1 is configured as a portion of an automobile HVAC system. The electromagnetic clutch assembly 1 includes a rotor 2, an armature 3, a rotating shaft 4, and an electromagnetic coil 5. The rotor 2 may normally be rotated about a central axis thereof by means of a belt (not shown) mechanically coupled to the output shaft of the engine, even when the compressor 10 is not in use. When not in use, a gap 6 is present between the rotor 2 and the armature 3, wherein the gap 6 may be maintained via use of a biasing device that normally biases the armature 3 in a direction away from the rotor 2. When it is desirable for the compressor 10 to be used, such as when cool air is desired within a passenger compartment of the automobile, the electromagnetic coil 5 is energized in a manner wherein an electromagnetic force attracts the armature 3 towards the rotor 2 to eliminate the gap 6. The armature 3 then engages the rotor 2 to transfer power from the driving belt to the shaft 4, thereby driving the internal components of the compressor 10.

Compressors are trending toward the use of rotors having a smaller diameter in comparison to traditional compressors. The use of smaller diameter rotors advantageously reduces a packaging size and mass of the compressor, but such smaller diameter rotors also tend to have a higher bending stiffness in comparison to larger diameter rotors. This increased bending stiffness often results in the rotor having natural frequencies, and hence resonant frequencies, that align more closely with typical rotational speeds at which the rotor may be driven. If the rotor is driven at a rotational speed substantially similar to a natural frequency of the rotor, a self-induced resonance may occur. The periodic driving of the rotor at these frequencies can produce large amplitude oscillations within the rotor that produce an undesirable noise that can be heard within the passenger compartment of the automobile,

FIG. 2 illustrates the rotor 2 of the prior art electromagnetic clutch assembly 1 of FIG. 1. The rotor 2 extends in an axial direction from a front flange 12 configured to engage the armature 3 to a rear flange 13 formed opposite the front flange 12. A sheave 14 of the rotor 2 is formed intermediate the front flange 12 and the rear flange 13, wherein the sheave 14 is a portion of an outer surface of the rotor 2 configured to engage a continuous belt (not shown) used to rotate the rotor 2. As shown in FIGS. 3A and 3B, the rear flange 13 has a substantially constant cross-sectional shape along an entirety of the circumference of the rear flange 13. As such, the rear flange 13 is substantially symmetric about any line extending from an axis of rotation of the rotor 2 in a direction perpendicular to the axis of rotation.

One potential issue associated with the symmetric shape of the rear flange 13 illustrated in FIG. 2 is that the rotor 2 may have the same stiffness along multiple different bending planes of the rotor 2 due to the rotor 2 having a substantially identical cross-sectional shape about a circumference thereof. Such a configuration causes the rotor 2 to have multiple similar bending mode shapes all having the same natural frequency, thereby promoting the incidence of self-induced resonance when the rotor 2 is driven at these frequencies. The self-induced resonance of the rotor 2 tends to cause a disagreeable ringing noise within a passenger compartment of the motor vehicle when the rotor 2 is engaged with the armature 3.

It would therefore be desirable to produce a rotor for an electromagnetic clutch assembly of an automobile compressor that reduces the incidence of self-induced resonance by avoiding a condition wherein two or more similar bending modes of the rotor are caused by substantially similar natural frequencies.

### SUMMARY OF THE INVENTION

Compatible and attuned with the present invention, a rotor having a flange with a non-uniform cross-sectional shape about a circumference thereof configured to minimize an occurrence of self-induced resonance within the rotor has surprisingly been discovered.

In one embodiment of the invention, a rotor for an electromagnetic clutch assembly comprises a substantially cylindrical main body extending from a first end to a second end. The first end of the main body is configured to engage an armature of the electromagnetic clutch assembly and includes a first flange formed around a circumference thereof The second end of the main body includes a second flange formed around a circumference thereof. One of the first flange and the second flange has a non-uniform cross-sectional shape as the one of the first flange and the second flange extends circumferentially around the main body, the cross-sectional shape of the one of the first flange and the second flange taken through a plane extending parallel to an axis of rotation of the main body.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings:

FIG. 1 is a cross-sectional elevational view of an electromagnetic clutch assembly according to the prior art;

FIG. 2 is a rear perspective view of the rotor of the prior art illustrated in FIG. 1;

FIG. 3A is a fragmentary cross-sectional view of the rotor of the prior art illustrated in FIGS. 1 and 2 taken through the line 3A-3A of FIG. 2;

FIG. 3B is a fragmentary cross-sectional view of the rotor of the prior art illustrated in FIGS. 1 and 2 taken through the line 3B-3B of FIG. 2;

FIG. 4 is a rear perspective view of a rotor having a rear flange with a non-uniform cross-sectional shape about a circumference thereof according to an embodiment of the invention;

FIG. 5A is a fragmentary cross-sectional view of the rotor of FIG. 4 taken through the line 5A-5A of FIG. 4;

FIG. 5B is a fragmentary cross-sectional view of the rotor of FIG. 4 taken through the line 5B-5B of FIG. 4;

FIG. 6 is a front perspective view of a rotor having a rear flange with a non-uniform cross-sectional shape about a circumference thereof according to another embodiment of the invention;

FIG. 7 is a rear perspective view of a rotor having a rear flange with a non-uniform cross-sectional shape about a circumference thereof according to another embodiment of the invention;

FIG. 8 is a rear perspective view of a rotor having a rear flange with a non-uniform cross-sectional shape about a circumference thereof and a plurality of inserts according to another embodiment of the invention;

FIG. 9 is a rear perspective view of a rotor having a rear flange with a non-uniform cross-sectional shape about a circumference thereof according to another embodiment of the invention;

FIG. 10 is a right side elevational view of the rotor illustrated in FIG. 9;

FIG. 11 is a rear perspective view of a rotor having a sheave coupled thereto and a rear flange with a non-uniform cross-sectional shape about a circumference thereof according to another embodiment of the invention;

FIG. 12A is a fragmentary cross-sectional view of an outermost portion of the rotor illustrated in FIG. 11 along a portion of a rear flange thereof devoid of an indentation;

FIG. 12B is a fragmentary cross-sectional view of the outermost portion of the rotor illustrated in FIG. 11 along a portion of the rear flange thereof having an indentation formed therein;

FIG. 13 is a front perspective view of a rotor having a front flange with a non-uniform cross-sectional shape about a circumference thereof according to another embodiment of the invention;

FIG. 14A is a fragmentary cross-sectional view of an outermost portion of the rotor illustrated in FIG. 13 along a portion of a front flange thereof devoid of an indentation; and

FIG. 14B is a fragmentary cross-sectional view of the outermost portion of the rotor illustrated in FIG. 13 along a portion of the front flange thereof having an indentation formed therein.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

FIG. 4 illustrates a rotor 102 according to an embodiment of the invention. The rotor 102 may be configured for use with an electromagnetic clutch assembly of a motor vehicle, wherein the electromagnetic clutch assembly is configured to transfer torque to a component of the motor vehicle. For example, the rotor 102 may be used in place of the rotor 2 of the electromagnetic clutch assembly 1 illustrated in FIG. 1, wherein the rotor 102 may be configured to transfer torque to the compressor 10 mechanically coupled to the electromagnetic clutch assembly 1. However, it should be understood that the rotor 102 may be used in other electromagnetic clutch assemblies for other applications without departing from the scope of the present invention.

The rotor 102 includes a substantially cylindrical main body comprising a front flange 112, a rear flange 113, a sheave 114, and an inner portion 115. The front flange 112 is formed at a first end 103 of the rotor 102 and the rear flange 113 is formed at a second end 104 of the rotor 102. The first end 103 of the rotor 102 includes a substantially planar front face (not shown) configured to engage an armature of the electromagnetic clutch assembly to transfer torque from the rotor 102 to the armature. The front flange 112 forms a radially outwardly extending portion of the rotor 102 extending circumferentially around the first end 103 thereof, thereby causing the front flange 112 to be substantially annular in shape.

The second end 104 of the rotor 102 includes an annular opening 116 formed between an inner circumferential surface 117 of the rotor 102 and an outer circumferential surface 118 of the inner portion 115. The annular opening 116 extends from an inner surface 119 of the rotor 102 fanned at the first end 103 thereof and toward the second end 104 of the rotor 102. The annular opening 116 may be configured to receive a component of the electromagnetic clutch assembly such as an electromagnetic coil (not shown) used to magnetically attract the armature to the front face of the rotor 102. The inner portion 115 is substantially cylindrical in shape and extends in an axial direction of the rotor 102 from the first end 103 toward the second end 104. The inner portion 115 includes an opening that may be configured to receive a bearing assembly of the electromagnetic clutch assembly therein to facilitate rotation of the rotor 102.

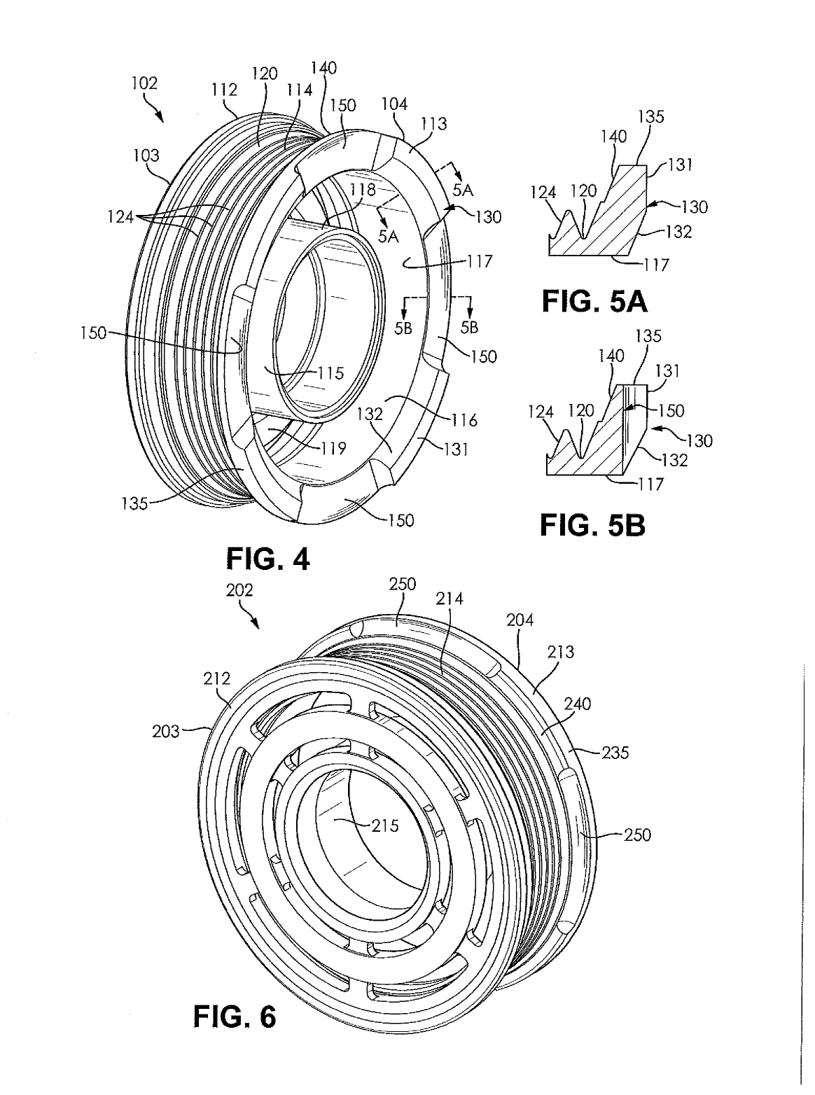

The rear flange 113 forms a radially outwardly extending portion of the rotor 102 surrounding the annular opening 116 at the second end 104 of the rotor 102. Accordingly, the rear flange 113 forms a rim of the rotor 102 connecting the inner circumferential surface 117 of the rotor 102 to an outer circumferential surface 120 of the rotor 102. The rear flange 113 includes a posterior surface 130, a flange circumferential surface 135, and an anterior surface 140 (as best illustrated in FIGS. 5A and 5B). The anterior surface 140 of the rear flange 113 is in facing relationship with the front flange 112 of the rotor 102. The posterior surface 130 is formed opposite the anterior surface 140 and may form a rearward surface of the rotor 102. The flange circumferential surface 135 forms a radial outermost portion of the rear flange 113 connecting the posterior surface 130 to the anterior surface 140. The posterior surface 130 may be formed to include both a planar surface 131 and an inclined surface 132. The planar surface 131 may be arranged perpendicular to an axis of rotation of the rotor 102 and the inclined surface 132 may be arranged at an acute angle with respect to the axis of rotation of the rotor 102. However, the rotor 102 may also be formed to have only a single planar surface or only a single inclined surface connecting the inner circumferential surface 117 of the rotor 102 to the flange circumferential surface 135 of the rear flange 113 without departing from the scope of the present invention.

The sheave 114 is formed on the outer circumferential surface 120 of the rotor 102 between the front flange 112 and the rear flange 113. The sheave 114 includes a plurality of annular projections 124 spaced apart from each other in an axial direction of the rotor 102, causing the sheave 114 to have a corrugated profile. The sheave 114 is configured to engage a belt (not shown) or other driving mechanism extending at least partially around the sheave 114. The belt may rotationally couple the rotor 102 to a crankshaft of a motor vehicle, for example. The belt may include a corrugated profile corresponding to the corrugated profile of the sheave 114. Accordingly, the front flange 112 and the rear flange 113 may be configured to surround the belt and restrain motion of the belt in the axial direction of the rotor 102.

As shown in FIGS. 4, 5A, and 5B, the rear flange 113 has a non-uniform cross-sectional shape as the rear flange 113 extends circumferentially around the second end 104 of the rotor 102 when each of the cross-sections is taken through a plane extending parallel to an axis of rotation of the rotor 102. More specifically, the rear flange 113 includes at least one non-uniform feature formed therein, wherein each of the non-uniform features may be an indentation 150 formed in the posterior surface 130 of the rear flange 113.

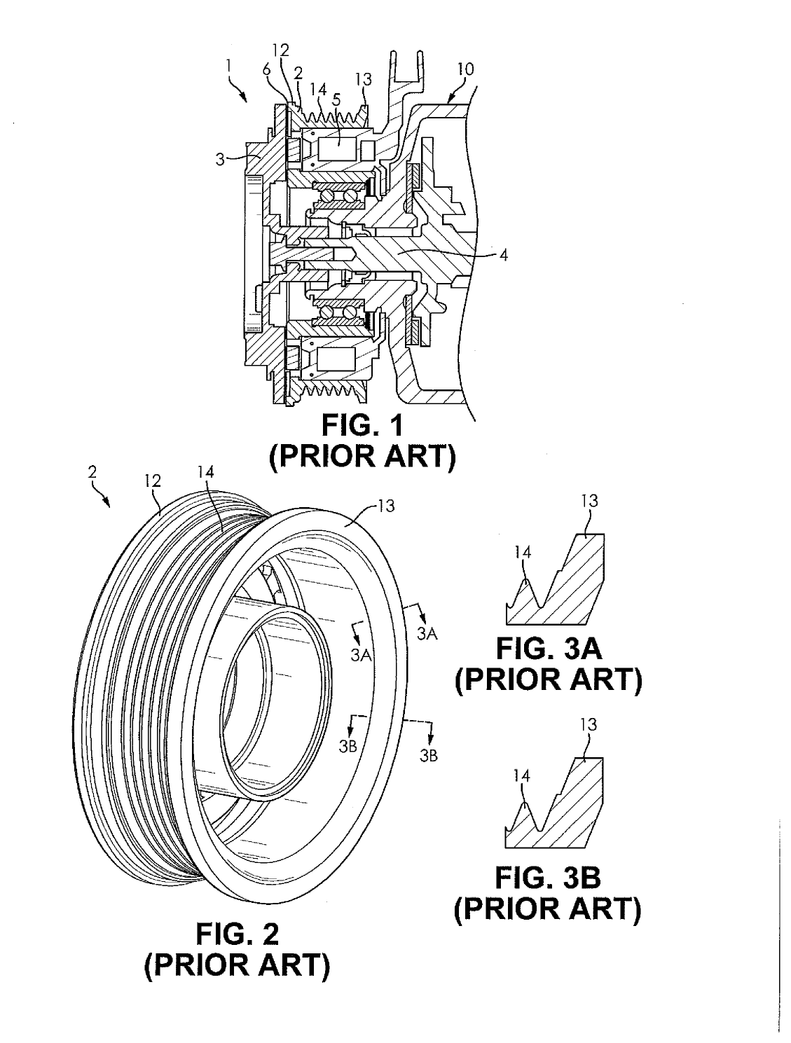

FIG. 5A illustrates a cross-section of the rear flange 113 along a portion of the rear flange 113 devoid of one of the indentations 150. As should be understood with reference to FIGS. 3A and 3B, those portions of the rear flange 113 devoid of one of the indentations 150 may each have a cross-sectional shape that is substantially similar to a cross-sectional shape of the rotor 2 illustrated in FIG. 2 about any portion of a circumference of the rotor 2. Accordingly, the portion of the rear flange 113 depicted in cross-section in FIG. 5A includes both the planar surface 131 and the inclined surface 132 oriented at an obtuse angle relative to each other.

In contrast, FIG. 5B illustrates a cross-section of the rear flange 113 along a portion of the rear flange 113 having one of the indentations 150 formed therein. The indentation 150 is shown as extending across a width of the posterior surface 130 of the rear flange 113 from the inner circumferential surface 117 to the flange circumferential surface 135, causing the posterior surface 130 to be substantially planar along each of the indentations 150. However, each of the indentations 150 may alternatively be formed in only a portion of the posterior surface 130 of the rear flange 113 without departing from the scope of the present invention, as desired. Each of the indentations 150 forms a portion of the posterior surface 130 of the rear flange 113 indented in an axial direction of the rotor 102 toward the first end 103 thereof. The indentations 150 are shown as being indented about half a distance formed between the posterior surface 130 and the anterior surface 140 along portions of the rear flange 113 adjacent each of the indentations 150, but the indentations 150 may be formed to have any suitable depth in the axial direction of the rotor 102. In some embodiments, each of the indentations 150 has a common depth in the axial direction of the rotor 102. In other embodiments, at least one of the indentations 150 may have a different depth in the axial direction of the rotor 102 in comparison to another one of the indentations 150, as desired.

The rotor 102 is shown in FIG. 4 as having four of the indentations 150 formed therein, wherein each of the indentations 150 is equally angularly spaced from an adjacent one of the indentations 150 about a circumference of the rear flange 113. Additionally, the indentations 150 are each shown as having a substantially equal length as measured in the circumferential direction of the rear flange 113. However, the rotor 102 may be formed to have any number of the indentations 150, and each of the indentations 150 may be formed to have a different length in the circumferential direction than does an adjacent one of the indentations 150. Furthermore, an angular spacing between adjacent ones of the indentations 150 may also be varied from one indentation 150 to the next, resulting in a non-uniform angular spacing between each of the indentations 150, as desired.

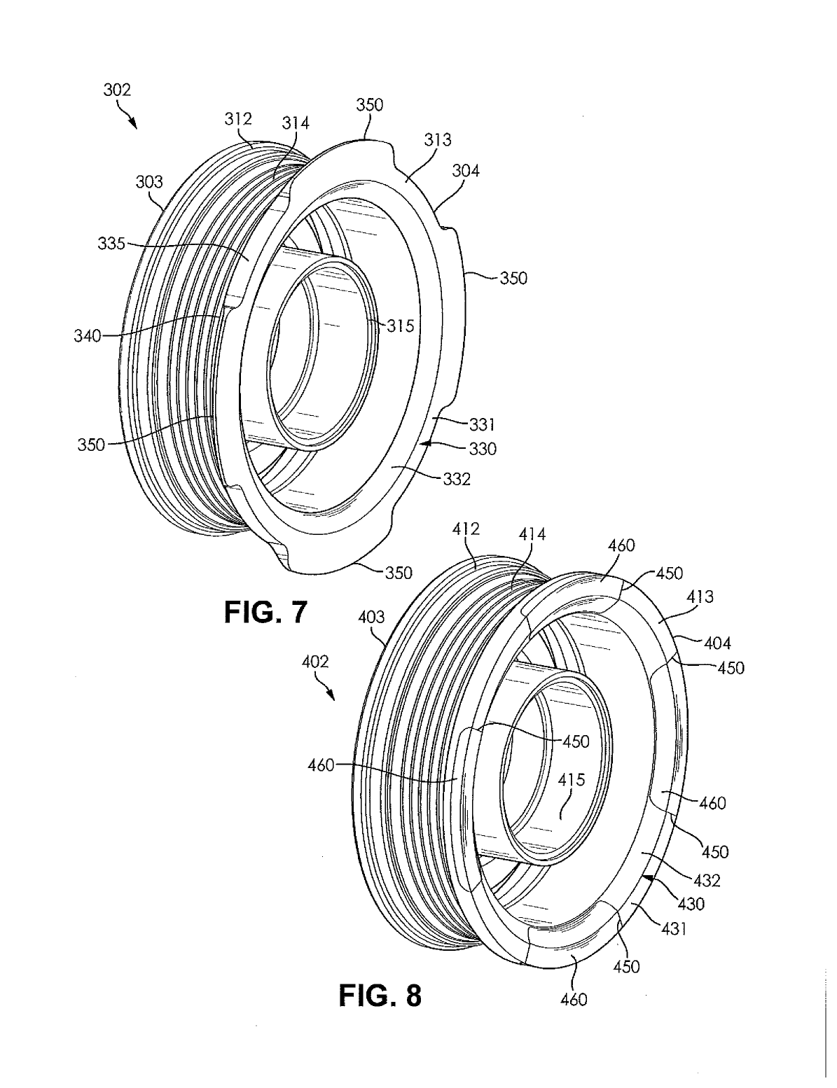

FIG. 6 illustrates a rotor 202 according to another embodiment of the invention. The rotor 202 may be suitable for use in an electromagnetic clutch assembly such as the electromagnetic clutch assembly 1 illustrated in FIG. 1, wherein the rotor 202 may be used in place of the rotor 2. However, the rotor 202 may be used for any suitable application, as desired.

The rotor 202 includes a substantially cylindrical main body comprising a front flange 212, a rear flange 213, a sheave 214, and an inner portion 215. The front flange 212 is formed at a first end 203 of the rotor 202 and the rear flange 213 is formed at a second end 204 of the rotor 202. The front flange 212 forms a radially outwardly extending portion of the rotor 202 at the first end 203 thereof. The rear flange 213 forms a radially outwardly extending portion of the rotor 202 at the second end 204 thereof.

The rear flange 213 includes a posterior surface (not shown), a flange circumferential surface 235, and an anterior surface 240. The anterior surface 240 of the rear flange 213 is in facing relationship with the front flange 212 of the rotor 202. The posterior surface is formed opposite the anterior surface 240. The flange circumferential surface 235 forms a radially outermost portion of the rear flange 213 connecting the posterior surface to the anterior surface 240.

The rear flange 213 has a non-uniform cross-sectional shape as the rear flange 213 extends circumferentially around the second end 204 of the rotor 202 when each of the cross-sections is taken through a plane extending parallel to an axis of rotation of the rotor 202. More specifically, the rear flange 213 includes at least one non-uniform feature formed therein, wherein each of the non-uniform features may be an indentation 250 formed in the anterior surface 240 of the rear flange 213.

As shown in FIG. 6, each of the indentations 250 is a portion of the anterior surface 240 of the rear flange 213 indented in the axial direction of the rotor 202 toward the posterior surface thereof. The indentations 250 are shown as being formed in a portion of the anterior surface 240 intersecting the flange circumferential surface 235, causing a perimeter of each of the indentations 250 to extend along portions of each of the anterior surface 240 and the flange circumferential surface 235. However, in other embodiments the indentations 250 may be formed in only a portion of the anterior surface 240 spaced apart from the flange circumferential surface 235, as desired.

The indentations 250 may have any suitable depth measured in the axial direction of the rotor 202. In some embodiments, each of the indentations 250 has a common depth in the axial direction of the rotor 202. In other embodiments, at least one of the indentations 250 may have a different depth in the axial direction of the rotor 202 in comparison to another one of the indentations 250, as desired.

The rotor 202 includes four of the indentations 250 formed therein (although only two are illustrated), wherein each of the indentations 250 is equally angularly spaced from an adjacent one of the indentations 250 about a circumference of the rear flange 213. Additionally, the indentations 250 are each shown as having a substantially equal length as measured in a circumferential direction of the rear flange 213. However, the rotor 202 may be formed to have any number of the indentations 250, and each of the indentations 250 may be formed to have a different length in the circumferential direction than does an adjacent one of the indentations 250. Furthermore, an angular spacing between adjacent ones of the indentations 250 may also be varied from one indentation 250 to the next, resulting in a non-uniform angular spacing between each of the indentations 250, as desired.

FIG. 7 illustrates a rotor 302 according to another embodiment of the invention. The rotor 302 may be suitable for use in an electromagnetic clutch assembly such as the electromagnetic clutch assembly 1 illustrated in FIG. 1, wherein the rotor 302 may be used in place of the rotor 2. However, the rotor 302 may be used for any suitable application, as desired.

The rotor 302 includes a substantially cylindrical main body comprising a front flange 312, a rear flange 313, a sheave 314, and an inner portion 315. The front flange 312 is formed at a first end 303 of the rotor 302 and the rear flange 313 is formed at a second end 304 of the rotor 302. The front flange 312 forms a radially outwardly extending portion of the rotor 302 at the first end 303 thereof. The rear flange 313 forms a radially outwardly extending portion of the rotor 302 at the second end 304 thereof.

The rear flange 313 includes a posterior surface 330, a flange circumferential surface 335, and an anterior surface 340. The anterior surface 340 of the rear flange 313 is in facing relationship with the front flange 312 of the rotor 302. The posterior surface 330 is formed opposite the anterior surface 340. The flange circumferential surface 335 forms an outer portion of the rear flange 313 connecting the posterior surface 330 to the anterior surface 340. The posterior surface 330 may be formed to include both a planar surface 331 and an inclined surface 332. The planar surface 331 may be arranged perpendicular to an axis of rotation of the rotor 302 and the inclined surface 332 may be arranged at an acute angle with respect to the axis of rotation of the rotor 302.

The rear flange 313 has a non-uniform cross-sectional shape as the rear flange 313 extends circumferentially around the second end 304 of the rotor 302 when each of the cross-sections is taken through a plane extending parallel to an axis of rotation of the rotor 302. More specifically, the rear flange 313 includes at least one non-uniform feature formed therein, wherein each of the non-uniform features may be a projection 350 formed in the flange circumferential surface 335 of the rear flange 313.

As shown in FIG. 7, each of the projections 350 is a portion of the rear flange circumferential surface 335 that projects radially outwardly away from the otherwise substantially annular shape of the flange circumferential surface 335, causing the flange circumferential surface 335 to have an undulating profile relative to the otherwise annular shape of the rear flange 313. Each of the projections 350 may be formed in a manner wherein a portion of the anterior surface 340 of the rear flange 313 extends radially outwardly at an inclined angle until the inclined portion meets a radially outwardly extending portion of the planar posterior surface 330. Accordingly, each of the projections 350 may be formed to have a decreasing thickness as each of the projections 350 extends radially outwardly from an axis of rotation of the rotor 302. However, the projections 350 may also be formed to have a uniform thickness along a length thereof, as desired.

The projections 350 may have any suitable height measured in the radial direction of the rotor 302. In some embodiments, each of the projections 350 has a common height in the radial direction of the rotor 302. In other embodiments, at least one of the projections 350 may have a different height in the radial direction of the rotor 302 in comparison to another one of the projections 350, as desired.

The rotor 302 includes four of the projections 350 formed therein, wherein each of the projections 350 is equally angularly spaced from an adjacent one of the projections 350 about a circumference of the rear flange 313. Additionally, the projections 350 are each shown as having a substantially equal length as measured in a circumferential direction of the rear flange 313. However, the rotor 302 may be formed to have any number of the projections 350, and each of the projections 350 may be formed to have a different length in the circumferential direction than does an adjacent one of the projections 350. Furthermore, an angular spacing between adjacent ones of the projections 350 may also be varied from one projection 350 to the next, resulting in a non-uniform angular spacing between each of the projections 350, as desired.

FIG. 8 illustrates a rotor 402 according to another embodiment of the invention. The rotor 402 may be suitable for use in an electromagnetic clutch assembly such as the electromagnetic clutch assembly 1 illustrated in FIG. 1, wherein the rotor 402 may be used in place of the rotor 2. However, the rotor 402 may be used for any suitable application, as desired.

The rotor 402 includes a substantially cylindrical main body comprising a front flange 412, a rear flange 413, a sheave 414, and an inner portion 415. The front flange 412 is formed at a first end 403 of the rotor 402 and the rear flange 413 is formed at a second end 404 of the rotor 402. The front flange 412 forms a radially outwardly extending portion of the rotor 402 at the first end 403 thereof. The rear flange 413 forms a radially outwardly extending portion of the rotor 402 at the second end 404 thereof.

The rear flange 413 includes a posterior surface 430, a flange circumferential surface 435, and an anterior surface (not shown). The anterior surface of the rear flange 413 is in facing relationship with the front flange 412 of the rotor 402. The posterior surface 430 is formed opposite the anterior surface. The flange circumferential surface 435 forms a radially outermost portion of the rear flange 413 connecting the posterior surface 430 to the anterior surface. The posterior surface 430 may be formed to include both a planar surface 431 and an inclined surface 432. The planar surface 431 may be arranged perpendicular to an axis of rotation of the rotor 402 and the inclined surface 432 may be arranged at an acute angle with respect to the axis of rotation of the rotor 402.

The rear flange 413 has a non-uniform cross-sectional shape as the rear flange 413 extends circumferentially around the second end 404 of the rotor 402 when each of the cross-sections is taken through a plane extending parallel to an axis of rotation of the rotor 402. More specifically, the rear flange 413 includes at least one non-uniform feature formed therein, wherein each of the non-uniform features may be an indentation 450 formed in the posterior surface 430 of the rear flange 413 having an insert 460 disposed therein.

With renewed reference to FIG. 4, each of the indentations 450 formed in the rotor 402 may have substantially the same shape and configuration as each of the indentations 150 formed in the rotor 102. However, the rotor 402 differs from the rotor 102 in that each of the indentations 450 formed in the rotor 402 includes one of the inserts 460 disposed therein. As shown in FIG. 8, when the inserts 460 are disposed in the indentations 450 the rotor 402 has an outward appearance closely resembling the rotor 2 illustrated in FIG. 2. Accordingly, each of the inserts 460 has a shape and size corresponding to a shape and size of each of the indentations 450 to give the rear flange 413 a consistent profile around a circumference thereof when the inserts 460 are disposed in the indentations 450. The inserts 460 may be coupled to the rotor 402 along the indentations 450 using any known coupling method, including brazing, welding, or the use of a suitable bonding agent, as non-limiting examples.

The inserts 460 are formed from a different material than a material forming the remainder of the rotor 402, wherein the material forming the inserts 460 is selected to have different material characteristics from the material forming the remainder of the rotor 402. For example, the material forming each of the inserts 460 may be selected to have a different elastic modulus (stiffness) in comparison to the remainder of the rotor 402 in order for each of the inserts 460 to react differently to a bending moment acting on the rotor 402.

The rotor 402 is shown in FIG. 8 as having four of the indentations 450 formed therein each having a corresponding one of the inserts 460, wherein each of the indentations 450 is equally angularly spaced from an adjacent one of the indentations 450 about a circumference of the rear flange 413. Additionally, the indentations 450 and corresponding inserts 460 are each shown as having a substantially equal length as measured in a circumferential direction of the rear flange 413. However, the rotor 402 may be formed to have any number of the indentations 450 and inserts 460, and each of the indentations 150 and inserts 460 may be formed to have a different length in the circumferential direction than does an adjacent one of the indentations 150 and inserts 460. Furthermore, an angular spacing between adjacent ones of the indentations 450 and inserts 460 may also be varied, resulting in a non-uniform angular spacing between the indentations 450 and inserts 460, as desired.

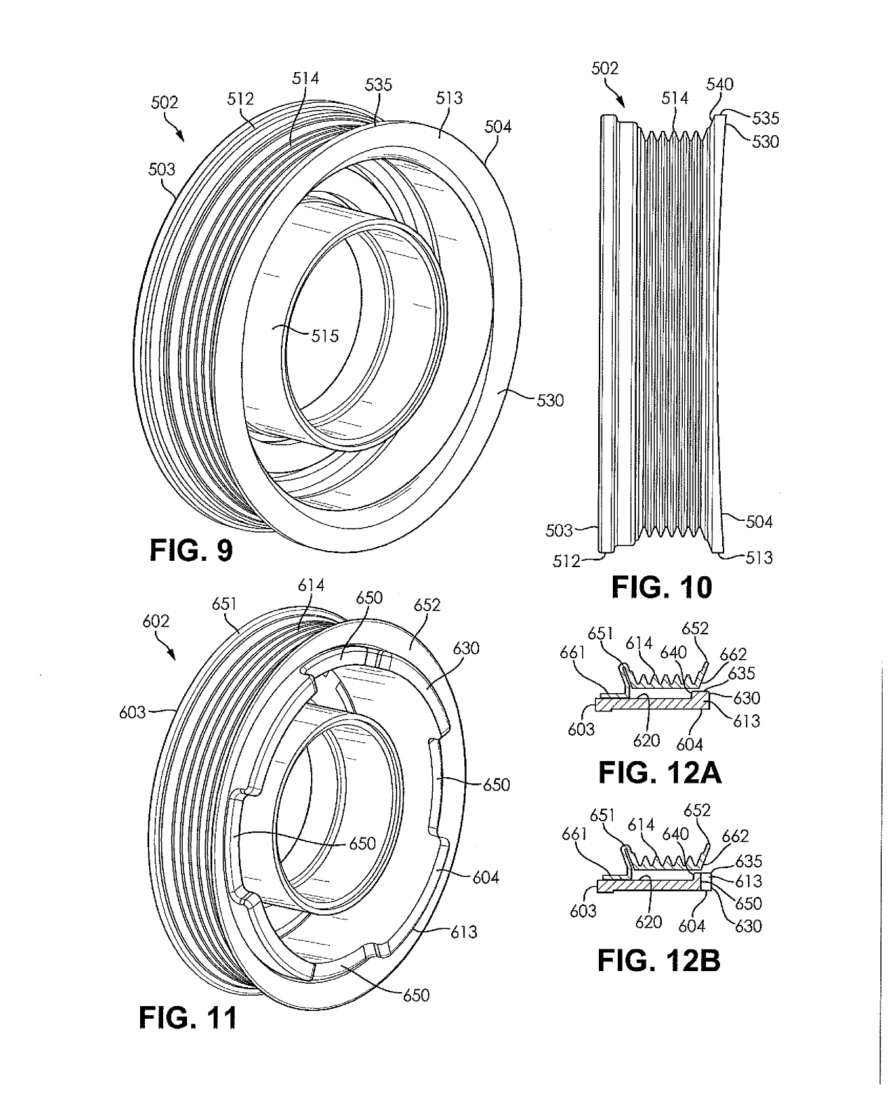

FIGS. 9 and 10 illustrate a rotor 502 according to another embodiment of the invention. The rotor 502 may be suitable for use in an electromagnetic clutch assembly such as the electromagnetic clutch assembly 1 illustrated in FIG. 1, wherein the rotor 502 may be used in place of the rotor 2. However, the rotor 502 may be used for any suitable application, as desired.

The rotor 502 includes a substantially cylindrical main body comprising a front flange 512, a rear flange 513, a sheave 514, and an inner portion 515. The front flange 512 is formed at a first end 503 of the rotor 502 and the rear flange 513 is formed at a second end 504 of the rotor 502. The front flange 512 forms a radially outwardly extending portion of the rotor 502 at the first end 503 thereof. The rear flange 513 forms a radially outwardly extending portion of the rotor 502 at the second end 504 thereof.

The rear flange 513 includes a posterior surface 530, a flange circumferential surface 535, and an anterior surface 540. The anterior surface 540 of the rear flange 513 is in facing relationship with the front flange 512 of the rotor 502. The posterior surface 530 is formed opposite the anterior surface 540. The flange circumferential surface 535 forms a radially outermost portion of the rear flange 513 connecting the posterior surface 530 to the anterior surface 540.

The posterior surface 530 of the rear flange 513 is formed to have a concave profile extending from one side of the rear flange 513 to an oppositely arranged side thereof, as best shown in FIG. 10. Accordingly, the rear flange 513 has a varying thickness as measured between the posterior surface 530 and the anterior surface 540 thereof in an axial direction of the rotor 502. FIG. 10 illustrates the rotor 502 from an angle wherein an uppermost portion and a lowermost portion of the rear flange 513 each have a maximized thickness and wherein a central portion of the rear flange 513 has a minimized thickness. As such, the rear flange 513 has a non-uniform cross-sectional shape as the rear flange 513 extends circumferentially around the second end 504 of the rotor 502 when each of the cross-sections is taken through a plane extending parallel to an axis of rotation of the rotor 502.

FIGS. 11, 12A, and 12B illustrate a rotor 602 according to another embodiment of the invention. The rotor 602 may be suitable for use in an electromagnetic clutch assembly such as the electromagnetic clutch assembly 1 illustrated in FIG. 1, wherein the rotor 602 may be used in place of the rotor 2. However, the rotor 602 may be used for any suitable application, as desired.

The rotor 602 includes a substantially cylindrical main body, but the rotor 602 differs significantly from the rotors 2, 102, 202, 302, 402, 502 in that the rotor 602 includes a separately formed sheave 614 that is subsequently coupled to an outer circumferential surface 620 of the rotor 602. The sheave 614 includes a first flanged portion 651 formed adjacent a first end 661 thereof and a second flanged portion 652 formed adjacent a second end 662 thereof The first flanged portion 651 of the sheave 614 is formed adjacent a first end 603 of the rotor 602 and the second flanged portion 652 is formed adjacent a second end 604 of the rotor 602, as best shown in FIGS. 12A and 12B. The first flanged portion 651 and the second flanged portion 652 may be configured to maintain an axial position of a belt (not shown) used to drive the rotor 602.

The rotor 602 may include a rear flange 613 formed at the second end 604 thereof, wherein the rear flange 613 is a radially outwardly extending portion of the rotor 602. The rear flange 613 may include a posterior surface 630, a flange circumferential surface 635, and an anterior surface 640 (illustrated in FIGS. 12A and 12B). The posterior surface 630 may be substantially planar and may be arranged perpendicular to an axis of rotation of the rotor 602. Although the rotor 602 has been described as having the radially outwardly extending rear flange 613, it should also be understood that the rotor 602 may instead be formed wherein the outer circumferential surface 620 extends linearly before intersecting a substantially planar surface forming the second end 604 of the rotor 602, as desired.

The rear flange 613 has a non-uniform cross-sectional shape as the rear flange 613 extends circumferentially around the second end 604 of the rotor 602 when each of the cross-sections is taken through a plane extending parallel to an axis of rotation of the rotor 602. More specifically, the rear flange 613 includes at least one non-uniform feature formed therein, wherein each of the non-uniform features may be an indentation 650 formed in the posterior surface 630 of the rear flange 613.

As shown in FIG. 11, each of the indentations 650 is a portion of the posterior surface 630 of the rotor 602 indented in the axial direction of the rotor 602 toward the first end 603 thereof. Each of the indentations 650 is shown as extending across a width of the posterior surface 630 of the rear flange 613, causing the posterior surface 630 to be substantially planar along each of the indentations 650. However, each of the indentations 650 may alternatively be formed in only a portion of the posterior surface 630 of the rear flange 613 without departing from the scope of the present invention, as desired.

FIG. 12A illustrates a fragmentary cross-section of a radially outermost portion of the rotor 602 including the rear flange 613 along a portion of the rear flange 613 devoid of one of the indentations 650. The rear flange 613 is shown as extending in the axial direction of the rotor 602 beyond at least a portion of the second flanged portion 652 of the sheave 614. In contrast, FIG. 12B illustrates a fragmentary cross-section of a radially outermost portion of the rotor 602 including the rear flange 613 along a portion of the rear flange 613 having one of the indentations 650 formed therein. The rear flange 613 is shown as extending in the axial direction of the rotor 602 to be substantially in alignment with a base of the second flanged portion 652 of the sheave 614. The indentations 650 are shown as being indented about half a distance formed between the posterior surface 640 and the anterior surface 630 along a portion of the rear flange 613 adjacent each of the indentations 650, but the indentations 650 may be formed to have any suitable depth in the axial direction of the rotor 602. In some embodiments, each of the indentations 650 has a common depth in the axial direction of the rotor 602. In other embodiments, at least one of the indentations 650 may have a different depth in the axial direction of the rotor 602 in comparison to another one of the indentations 650, as desired.

The rotor 602 includes four of the indentations 650 formed therein, wherein each of the indentations 650 is equally angularly spaced from an adjacent one of the indentations 650 about a circumference of the rear flange 613. Additionally, the indentations 650 are each shown as having a substantially equal length as measured in a circumferential direction of the rear flange 613. However, the rotor 602 may be formed to have any number of the indentations 650, and each of the indentations 650 may be formed to have a different length in the circumferential direction than does an adjacent one of the indentations 650. Furthermore, an angular spacing between adjacent ones of the indentations 650 may also be varied from one indentation 650 to the next, resulting in a non-uniform angular spacing between each of the indentations 650, as desired.

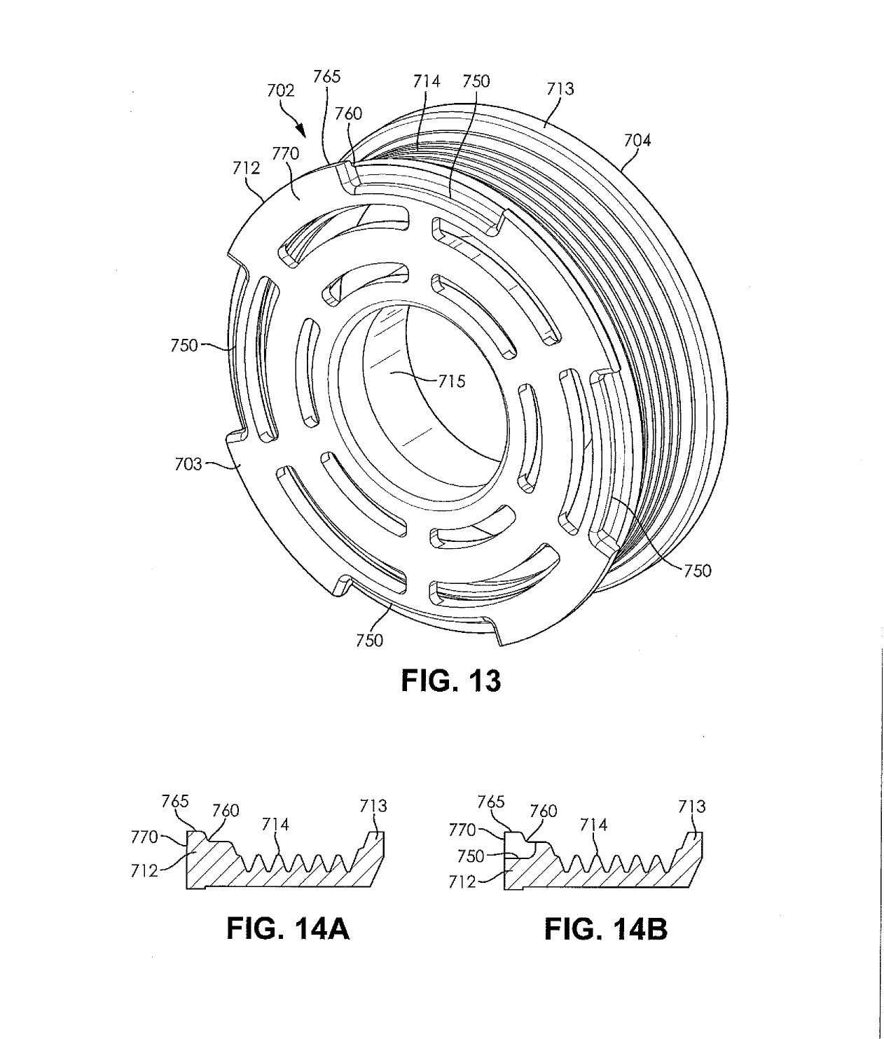

FIGS. 13, 14A, and 14B illustrate a rotor 702 according to another embodiment of the invention. The rotor 702 may be suitable for use in an electromagnetic clutch assembly such as the electromagnetic clutch assembly 1 illustrated in FIG. 1, wherein the rotor 702 may be used in place of the rotor 2. However, the rotor 702 may be used for any suitable application, as desired.

The rotor 702 includes a substantially cylindrical main body comprising a front flange 712, a rear flange 713, a sheave 714, and an inner portion 715. The front flange 712 is formed at a first end 703 of the rotor 702 and the rear flange 713 is formed at a second end 704 of the rotor 702. The front flange 712 forms a radially outwardly extending portion of the rotor 702 at the first end 703 thereof. The rear flange 713 forms a radially outwardly extending portion of the rotor 702 at the second end 704 thereof.

As best shown in FIG. 14A, which illustrates a fragmentary cross-section of a radial outermost portion of the rotor 702, the front flange 712 includes a posterior surface 760, a flange circumferential surface 765, and an anterior surface 770. The anterior surface 770 of the front flange 712 may be in facing relationship with an armature of the electromagnetic clutch assembly. The posterior surface 760 is formed opposite the anterior surface 770 and is in facing relationship with the rear flange 713 of the rotor 702. The flange circumferential surface 765 forms a radially outermost portion of the front flange 712 connecting the posterior surface 760 to the anterior surface 770.

The rotor 702 differs from the rotors 102, 202, 302, 402, 502, 602 in that the front flange 712 of the rotor 702 has a non-uniform cross-sectional shape as the front flange 712 extends circumferentially around the first end 703 of the rotor 702 when each of the cross-sections is taken through a plane extending parallel to an axis of rotation of the rotor 702. More specifically, the front flange 712 includes at least one non-uniform feature formed therein, wherein each of the non-uniform features may be an indentation 750 formed in the anterior surface 770 of the front flange 712.

As shown in FIG. 14B, each of the indentations 750 is a portion of the anterior surface 770 of the front flange 712 indented in the axial direction of the rotor 702 toward the posterior surface 760 thereof. The indentations 750 are shown as being formed in a portion of the anterior surface 770 intersecting the flange circumferential surface 765 and extending to the posterior surface 760, causing a perimeter of each of the indentations 750 to extend along portions of each of the anterior surface 770, the flange circumferential surface 765, and the posterior surface 760. However, in other embodiments the indentations 750 may be formed in only a portion of the anterior surface 770 spaced apart from the flange circumferential surface 765, as desired. Additionally, the indentations 750 may also not be formed to extend all the way in the axial direction to the posterior surface 760 of the front flange 712, but may instead only extend into a portion of the front flange 712.

The indentations 750 may have any suitable depth measured in the axial direction of the rotor 702. In some embodiments, each of the indentations 750 has a common depth in the axial direction of the rotor 702. In other embodiments, at least one of the indentations 750 may have a different depth in the axial direction of the rotor 702 in comparison to another one of the indentations 750, as desired. The indentations 750 may also have any suitable height as measured in a radial direction of the rotor 702. In some embodiments, each of the indentations 750 has a common height in the radial direction. In other embodiments, at least one of the indentations 750 may have a different height in the radial direction of the rotor 702 in comparison to another one of the indentations 750, as desired.

The rotor 702 includes four of the indentations 750 formed therein, wherein each of the indentations 750 is equally angularly spaced from an adjacent one of the indentations 750 about a circumference of the front flange 712. Additionally, the indentations 750 are each shown as having a substantially equal length as measured in a circumferential direction of the front flange 712. However, the rotor 702 may be formed to have any number of the indentations 750, and each of the indentations 750 may be formed to have a different length in the circumferential direction than does an adjacent one of the indentations 750. Furthermore, an angular spacing between adjacent ones of the indentations 750 may also be varied from one indentation 750 to the next, resulting in a non-uniform angular spacing between each of the indentations 750, as desired.

Each of the rotors 102, 202, 302, 402, 502, 602, 702 beneficially reduce the occurrence of self-induced resonance of the rotors 102, 202, 302, 402, 502, 602, 702 by introducing the non-uniform features in at least one of the rear flange 113, 213, 313, 413, 513, 613 thereof or the front flange 712 thereof. Typically, a rotor such as the rotor 2 of the prior art is substantially symmetric about a plurality of different axes extending perpendicularly to the axis of rotation of the rotor. This symmetric relationship causes the rotor 2 to include several different bending planes having substantially the same stiffness due to each of the bending planes having substantially the same cross-sectional shape. Accordingly, the rotor 2 may include a plurality of substantially similar mode shapes, wherein each of the substantially similar mode shapes corresponds to a substantially similar natural frequency of the rotor 2. For example, the rotor 2 may include two or more mode shapes that each occur when the rotor 2 is rotating at a single given frequency corresponding to two or more natural frequencies of the rotor 2. If the rotor 2 is rotated or otherwise oscillated at a frequency similar to those natural frequencies that are substantially similar to each other, the rotor 2 may encounter a self-induced resonance as a rotational speed of the rotor 2 approaches the common natural frequency shared by both mode shapes. The occurrence of resonance within the rotor 2 corresponds to the rotor 2 oscillating in a manner wherein a brief, amplified ringing noise may propagate from the rotor 2 when the rotor 2 engages the armature of the corresponding electromagnetic clutch assembly 1, thereby causing discomfort to a passenger in a vehicle having the rotor 2.

The inclusion of the non-uniform features in at least one of the rear flange 113, 213, 313, 413, 513, 613 of each of the rotors 102, 202, 302, 402, 502, 602 or the front flange 712 of the rotor 702 reduces the occurrence of self-induced resonance by varying a stiffness of each of the rotors 102, 202, 302, 402, 502, 602, 702 along a plurality of different bending planes formed within each of the rotors 102, 202, 302, 402, 502, 602, 702. The variance in stiffness along different bending planes of each of the rotors 102, 202, 302, 402, 502, 602, 702 causes each of the rotors 102, 202, 302, 402, 502, 602, 702 to have natural frequencies that are different from each other for otherwise substantially similar bending modes, thereby minimizing the occurrence of self-induced resonance that occurs when two or more natural frequencies of each of the rotors 102, 202, 302, 402, 502, 602, 702 occur simultaneously.

It should be understood that each of the non-uniform features shown and described herein may be adapted for use in any of the rotors 102, 202, 302, 402, 502, 602, including a combination of such features within a single rotor. For example, a rotor may include both a plurality of projections and a plurality of indentations formed therein, as desired.

Additionally, one skilled in the art should appreciate that any of the rotors 102, 202, 602, 702 having at least one indentation 150, 250, 650, 750 formed therein may be configured to receive at least one insert therein in similar fashion to the manner in which each of the inserts 460 is received in each of the indentations 450 of the rotor 402. Each of the inserts is accordingly formed from a different material than the remainder of each of the rotors 102, 202, 602, 702 to ensure that each of the inserts have a different stiffness than the remainder of each of the rotors 102, 202, 602, 702. As should be understood, each of the inserts to be inserted into the indentations 150, 250, 650, 750 has a size and shape configured to fill each void formed in each of the rotors 102, 202, 602, 702 to cause the combined rotor 102, 202, 602, 702 and insert assembly to have a substantially uniform cross-sectional shape similar to those portions of the rotors 102, 202, 602, 702 devoid of one of the inserts. The inserts may accordingly be disposed in and coupled to one of the front flange or the rear flange, depending on the configuration of the corresponding rotor 102, 202, 602, 702 and the placement of each of the corresponding indentations 150, 250, 650, 750 therein.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A rotor for a clutch assembly, the rotor comprising:
a substantially cylindrical main body extending from a first end to a second end, the first end configured to engage an armature of the clutch assembly and including a first flange formed around a circumference thereof, the second end including a second flange formed around a circumference thereof, wherein one of the first flange and the second flange has a non-uniform cross-sectional shape as the one of the first flange and the second flange extends circumferentially around the main body, the cross-sectional shape of the one of the first flange and the second flange taken through a plane extending parallel to an axis of rotation of the main body.

2. The rotor of claim 1, wherein the second flange has the non-uniform cross-sectional shape, the second flange extending radially outwardly around a circumference of the second end of the main body, the second flange including an anterior surface facing toward the first end of the main body, a posterior surface formed opposite the anterior surface, and an outer circumferential surface connecting the anterior surface to the posterior surface.

3. The rotor of claim 2, wherein the second flange includes at least one indentation formed in the posterior surface thereof.

4. The rotor of claim 3, wherein the at least one indentation extends across a width of the posterior surface of the second flange in a radial direction of the main body.

5. The rotor of claim 2, wherein the second flange includes a plurality of indentations formed in the posterior surface thereof, wherein each of the indentations is angularly spaced apart from an adjacent one of the indentations in a circumferential direction of the second flange.

6. The rotor of claim 2, wherein the second flange includes at least one indentation formed in the anterior surface thereof.

7. The rotor of claim 6, wherein the at least one indentation is formed in an edge defined by an intersection of the outer circumferential surface and the anterior surface of the second flange.

8. The rotor of claim 2, wherein the second flange includes a plurality of indentations formed in the anterior surface thereof, wherein each of the indentations is angularly spaced apart from an adjacent one of the indentations in a circumferential direction of the second flange.

9. The rotor of claim 2, wherein the second flange includes at least one projection extending radially outwardly from the outer circumferential surface thereof.

10. The rotor of claim 2, wherein the second flange includes a plurality of projections extending radially outwardly from the outer circumferential surface thereof, wherein each of the projections is angularly spaced apart from an adjacent one of the projections in a circumferential direction of the second flange.

11. The rotor of claim 2, wherein the posterior surface of the second flange has a concave profile.

12. The rotor of claim 11, wherein a thickness of the second flange measured between the posterior surface and the anterior surface varies from one side of the second flange to an oppositely arranged side of the second flange.

13. The rotor of claim 1, further comprising a sheave coupled to an outer circumferential surface of the main body between the first end and the second end of the main body.

14. The rotor of claim 13, wherein the second flange has the non-uniform cross-sectional shape and a posterior surface of the second flange facing away from the sheave includes at least one axially extending indentation formed therein.

15. The rotor of claim 1, wherein the first flange has the non-uniform cross-sectional shape and includes at least one indentation formed therein.

16. The rotor of claim 15, wherein the first flange extends radially outwardly around a circumference of the first end of the main body, wherein the at least one indentation is formed in an anterior surface of the first flange facing away from the second end of the main body, the at least one indentation extending in an axial direction of the main body.

17. The rotor of claim 1, wherein the non-uniform cross-sectional shape of the one of the first flange and the second flange is configured to vary a stiffness of the main body along at least one plane extending parallel to the axis of rotation of the main body.

18. The rotor of claim 1, wherein the non-uniform cross-sectional shape of the one of the first flange and the second flange is provided by at least one indentation formed in one of the first flange and the second flange, wherein an insert is disposed in the at least one indentation, a material forming the insert different from a material forming the main body.

19. The rotor of claim 18, wherein a stiffness of the material forming the insert is different from a stiffness of the material forming the main body.

20. The rotor of claim 18, wherein a shape and a size of the insert is substantially the same as an opening formed in the one of the first flange and the second flange caused by the introduction of the at least one indentation.
